(19) United States
(12) Patent Application Publication
(10) Pub. No.: US 2026/0124850 A1
(43) Pub. Date: May 7, 2026

(54) WRITING IMPLEMENTS

(71) Applicant: SOCIÉTÉ BIC, Clichy (FR)

(72) Inventors: Philippe LEFEBVRE, Clichy (FR); Julien LINTERMY, Clichy (FR); Olivier ALBENGE, Clichy (FR); Guilhem LAFFONT, Lille (FR); Philippine REYMONDON, Lille (FR)

(73) Assignee: SOCIÉTÉ BIC, Clichy Cedex (FR)

(21) Appl. No.: 18/686,265

(22) PCT Filed: Aug. 1, 2022
(86) PCT No.: PCT/EP2022/071496

§ 371 Date: Feb. 23, 2024

(30) Foreign Application Priority Data
Aug. 26, 2021 (EP) 21306159.1

(51) Int. Cl. B43K 5/18; B43K 5/02

(52) U.S. Cl. CPC B43K 5/1836; B43K 5/02

(57) ABSTRACT

A writing implement including a reservoir for storing a liquid, an applicator tip for depositing the liquid on a surface, a buffer connected to the reservoir and connected to the applicator tip so as to transport the liquid from the reservoir to the applicator tip, and a normally-open valve separating the buffer from the reservoir, the valve being configured to close, to prevent flow of the liquid from the reservoir to the buffer, in response to internal pressure within the reservoir exceeding a reference pressure outside of the reservoir by more than a predetermined amount.

This application claims priority to the European patent application EP 21306159.1, filed on Aug. 26, 2021, its content being incorporated herein by reference.

### FIELD

The present disclosure relates to writing implements, in particular writing implements of the free-ink type. As used herein, the term “free-ink” designates a writing implement in which a liquid that can be deposited on a surface to form indicia can be stored in a reservoir in a freely-flowing state, regardless of whether the liquid itself is actually ink. As used herein “liquid” may also refer to a suspension. In other words, in a free-ink writing implement, the ink is free to move or flow within the writing implement reservoir in accordance with the movements imposed by the user to the writing implement, i.e. in response to external forces such as motion, gravity and/or pressure that a user can selectively apply to a substrate, e.g. paper, metal, wood, plastic, etc.

### BACKGROUND

Free-ink-type writing implements (such as free-ink-type markers) are prone to leaks of stored liquid (e.g. ink) due to increases in pressure within the reservoir, as compared to ambient pressure.

In a conventional free-ink-type marker, ink is transported from the marker's reservoir to the marker's ink-deposition tip e.g. by way of a baffle system, including lamella, which serves to limit the speed at which ink is able to flow out of the marker. Aside from being complex and costly, this system is unable to prevent leaks when internal pressure within the reservoir remains elevated relative to ambient pressure for long periods of time.

U.S. Pat. No. 10,245,877 discloses a writing instrument including a barrel having a front end and an oppositely disposed rear end, an ink reservoir disposed within or formed within the barrel, and a nib in fluid communication with the ink reservoir. A valve or seal can be attached to the nib and actuatable by depression of the nib to open the the valve and allow fluid communication between the ink reservoir and the nib. Unfortunately, this system necessarily interferes with consistent dispensing of ink in situations where contact pressures applied to the nib are not sufficient to open the valve.

Chinese utility model CN 209 111 801 U discloses a circulation type water fountain pen including a pen holder, a pen cap, an ink storage bin and a pen head. The pen holder includes a water pen check valve, a sponge, a baffle and a pen plug. The top of the pen plug is provided with a pen vent. Unfortunately, leak prevention and the ability to deposit ink consistently require that the pen vent be exposed to the atmosphere, but this exposure also puts the pen vent at risk of clogging.

Therefore, there is room for improvement in free-ink-type writing implements.

### SUMMARY

It has been found that a free-ink-type writing implement should prevent leakage or leaks of stored liquid reliably while permitting the stored liquid to be deposited onto a surface even at low contact pressures between the surface and the applicator tip of the writing implement.

According to the present disclosure, a writing implement is provided. The writing implement includes a reservoir. The reservoir is for storing a liquid. The writing implement includes an applicator tip. The applicator tip is for depositing the liquid on a surface. The writing implement includes a baffle or a buffer system or arrangement. The baffle/buffer system/arrangement is connected to the reservoir via a valve and connected to the applicator tip so as to transport the liquid from the reservoir to the applicator tip. The valve is normally-open and is configured to close, to prevent flow of the liquid from the reservoir to the baffle/buffer system/arrangement, in response to internal pressure within the reservoir exceeding a reference pressure outside of the reservoir by more than a predetermined amount of pressure. The baffle/buffer system/arrangement enables liquid (e.g. ink) flow regulation towards the front part of the writing implement, i.e. the applicator tip.

The valve may include a separator wall. The separator wall may include one or more fluid passages for fluid exchange/communication between the reservoir and the baffle/buffer system/arrangement. The valve may include a flow control portion. The flow control portion may be arranged towards the reservoir with respect to the separator wall so as to hide the one or more fluid passages while the valve is in the open position, as viewed along a direction of flow of the liquid through one of the one or more fluid passages from the reservoir to the baffle/buffer system/arrangement. The flow control portion may be configured to contact a sealing surface of the separator wall to close the valve.

The flow control portion may be deformable so as to contact the sealing surface to close the valve.

The valve may include a mounting stem configured to cooperate in a penetrative manner with a mounting through-hole provided in the separator wall to connect the flow control portion to the separator wall.

The valve may include a spacer between the flow control portion and the sealing surface. The mounting stem may include a neck portion configured to fit within the mounting through-hole. The mounting stem may include a retainer portion positioned opposite the neck portion from the spacer such that when the neck portion is arranged within the mounting through-hole, the separator wall is arranged between the spacer and the retainer portion.

The retainer portion may be configured to be snap-fitted through the mounting through-hole.

The mounting stem may include a tip portion which is narrower than the mounting through-hole for guiding the retainer portion and neck portion into position with respect to the mounting through-hole.

A separation distance between the flow control portion and the sealing surface may be 0.25 mm (millimeters) or less when the valve is in the open position.

The one or more fluid passages may have a total cross-sectional area of 4.5 mm² (square millimeters) or less, preferably 4.02 mm² or less.

The pressure predetermined amount may be 10 mbar (millibars) or less.

The pressure predetermined amount may be equal to or greater than 4 mbar (millibars) and equal to or less than 8 mbar (millibars).

The pressure predetermined amount may be 6 mbar (millibars)+/−20%.

The valve may be an umbrella valve. Umbrella valves comprise a dome shaped elastic valve body which provides a sealing function in the backflow direction when mounted in a seat such as umbrella check valves which are commercially available from e.g. Vernay Laboratories, Inc. under commercial reference VA5219.

The baffle/buffer system/arrangement may include a gas passage for admitting gas into the writing implement.

The gas passage may be configured to admit gas into the baffle/buffer system/arrangement. The reservoir may be configured to accept gas from the baffle/buffer system/arrangement via the valve.

The writing implement may include a removable closure configured to reversibly and concurrently separate the applicator tip and gas passage from an environment of the writing implement.

A writing implement as described herein allows the reservoir to be open in normal conditions, i.e. conditions in a steady state or not submitted to specific constraints such as high temperatures or low external pressures, and to be closed automatically so as to prevent leaks of the liquid stored therein.

### BRIEF DESCRIPTION OF THE DRAWINGS

The disclosure may be more completely understood in consideration of the following detailed description of aspects of the disclosure in connection with the accompanying drawings, in which:

FIG. 1A shows an exemplary free-ink writing implement in cross-sectional view.

FIG. 1B shows the writing implement of FIG. 1A as seen from an applicator tip thereof.

FIG. 2 shows a detailed cross-sectional view of a valve visible in FIG. 1A.

FIG. 3 shows a three-dimensional representation of a valve body visible in FIG. 1A.

FIG. 4 shows a cross-sectional view of a valve body visible in FIG. 1A.

FIG. 5 shows a cross-sectional view of a baffle/buffer system and applicator tip.

FIG. 6 shows a cross-sectional view of the baffle/buffer system of FIG. 5 and a valve.

FIG. 7 shows a detailed cross-sectional view of a valve in an open position.

FIG. 8 shows the valve of FIG. 7 in a closed position.

### DETAILED DESCRIPTION

As used in this disclosure and the appended claims, the singular forms “a”, “an”, and “the” include plural referents unless the content clearly dictates otherwise. As used in this disclosure and the appended claims, the term “or” is generally employed in its sense including “and/or” unless the content clearly dictates otherwise.

The following detailed description should be read with reference to the drawings. The detailed description and the drawings, which are not necessarily to scale, depict illustrative aspects and are not intended to limit the scope of the disclosure. The illustrative aspects depicted are intended only as exemplary.

Although the terms “first,” “second,” etc. may be used herein to describe various elements, components, regions, layers, sections, and/or parameters, these elements, components, regions, layers, sections, and/or parameters should not be limited by these terms. These terms are only used to distinguish one element, component, region, layer, or section from another region, layer, or section. Thus, a first element, component, region, layer, or section discussed herein could be termed a second element, component, region, layer, or section without departing from the teachings of the present disclosure.

Identical reference numerals/symbols designate equivalent components/features.

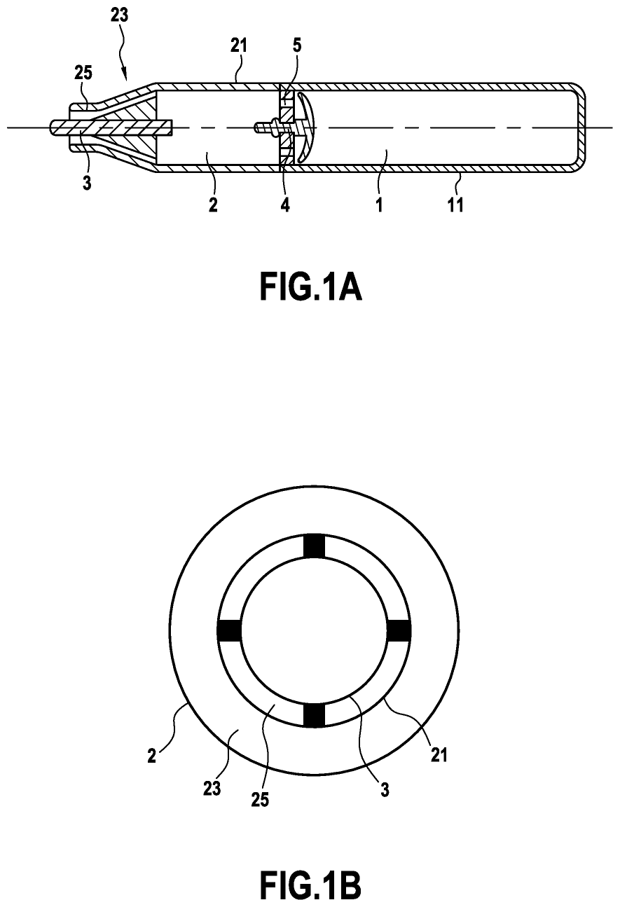

FIG. 1A shows an exemplary free-ink writing implement in cross-sectional view. It is reiterated that the term “free-ink” does not imply that the disclosed writing implement is only suitable for depositing or configured to deposit ink, but rather that the liquid is stored in a reservoir in an unconstrained state so as to move or flow freely within the reservoir. In other words, the liquid may circulate instantaneously on either side of the reservoir, e.g. as a result of gravity.

The writing implement includes a tank 1 defining a free-ink reservoir with a rigid, closed wall 11 having an opening via which fluid (liquid or gas) may flow into or out of the reservoir. The tank 1 is configured to store liquid (e.g. ink) suitable for application to a surface as indicia.

The writing implement includes an applicator tip 3 for applying indicia to a surface using the liquid stored in the tank 1.

The writing implement includes a baffle/buffer system 2 which is connected to the tank 1 in a liquid-tight manner.

During use, liquid is deposited onto a surface via of the applicator tip 3. The applicator tip 3 receives liquid from the baffle/buffer 2 system. The buffer system 2 receives liquid from the tank 1.

The baffle/buffer system 2 includes a rigid peripheral wall 21 for transporting fluid (e.g. liquid and/or gas) between the tank 1 and the applicator tip 3. The peripheral wall 21 is connected in a sealed manner to a nib portion 23 of the baffle/buffer system 2, which is configured to retain the applicator tip 3. The baffle/buffer system 2 may be considered in this embodiment as a baffle/buffer chamber including the rigid peripheral wall 21.

In FIG. 1A, the writing implement is represented in an open configuration, insofar as the applicator tip 3 is exposed to the environment. However, it is contemplated that the nib portion 23 may be shaped so as to cooperate with a cap, cover, plug, or other type of closure or closing element in order to separate the applicator tip 3 from the environment when the writing implement is not in use.

As liquid is deposited onto the surface, gas (e.g. air) from the environment of the writing implement may be admitted into the writing implement by way of at least one gas passage 25. In this way, it may be possible to ensure a relatively steady flow of liquid onto the surface, by preventing excessive vacuum formation upstream of the applicator tip 3 (e.g. within the buffer 2). It is also contemplated that gas may flow through the gas passage 25 in order to equalize pressure within the baffle/buffer system 2 with respect to the environment of the writing implement.

In FIG. 1A, the gas passage 25 is provided in the nib portion 23, so that the gas passage 25 may be closed by the closure or closing element when the writing implement is not in use.

When the gas passage 25 is not closed, the baffle/buffer system 2 is able to remain substantially at ambient pressure. Capillary action from the nib 3 may prevent leakage of liquid from the baffle/buffer system 2 through the gas passage 25.

FIG. 1B shows the writing implement of FIG. 1A as seen from the applicator tip 3. The peripheral wall 21 contacts the applicator tip 3 so as to stabilize the applicator tip 3 in the baffle/buffer system 2. Four gas passages 25 are formed as gaps between the peripheral wall 21 and the applicator tip 3, as seen when viewed from the applicator tip 3 towards the baffle/buffer system 2. Although the illustrated example includes four gas passages 25, it is contemplated that, if any gas passages are provided at all, there may be provided as few as one, two, three, or even more than four, for example five or six. The cross-sectional areas of the gas passages 25 depend on the configurations of the writing instruments and in particular their dimensions. By way of example, each gas passage 25 may have a cross-sectional area of 2.15 mm² (square millimeters), with a dimension of 0.65 mm (millimeters) as measured normal to the surface of the applicator tip 3.

Returning now to FIG. 1A, the writing implement includes a valve arranged between the tank 1 and the baffle/buffer system 2. The valve is of the normally-open type, and is configured to close in response to pressure inside the tank 1 exceeding a reference pressure by more than a predetermined amount. The reference pressure is measured outside of the tank 1. As a non-limiting example, the ambient pressure in the environment of the writing implement may be taken as the reference pressure, or internal pressure within the baffle/buffer system 2 may be taken as the reference pressure. For example, the valve may remain open if the pressure difference across the valve is less than or equal to 10 mbar (millibars), and close if the pressure difference across the valve exceeds this amount. However other values for the predetermined amount are also contemplated, including equal to or greater than 4 mbar and less than or equal to 8 mbar, equal to or greater than 5 mbar and less than or equal to 7 mbar, or 6 mbar (+/−20%).

In FIG. 1A, the valve separates the tank 1 and the baffle/buffer system 2. When the valve is in an open position, fluid exchange is possible between the tank 1 and the baffle/buffer system 2; when the valve is in a closed position, flow of liquid from the tank 1 to the baffle/buffer system 2 is blocked.

Although liquid is prevented from flowing from the tank 1 to the baffle/buffer system 2 when the valve is closed, liquid which flowed from the tank 1 into the baffle/buffer system 2 when the valve was open remains accessible to the applicator tip 3. Thus, even when the valve is closed, a user may continue to be able to deposit indicia. Since the buffer 2 is maintained at ambient pressure (while the writing implement is in the open configuration), the indicia may be deposited with consistency for as long as sufficient amounts of liquid remain available in the baffle/buffer 2 system.

The valve includes a valve body 4 which cooperates with a separator wall 5.

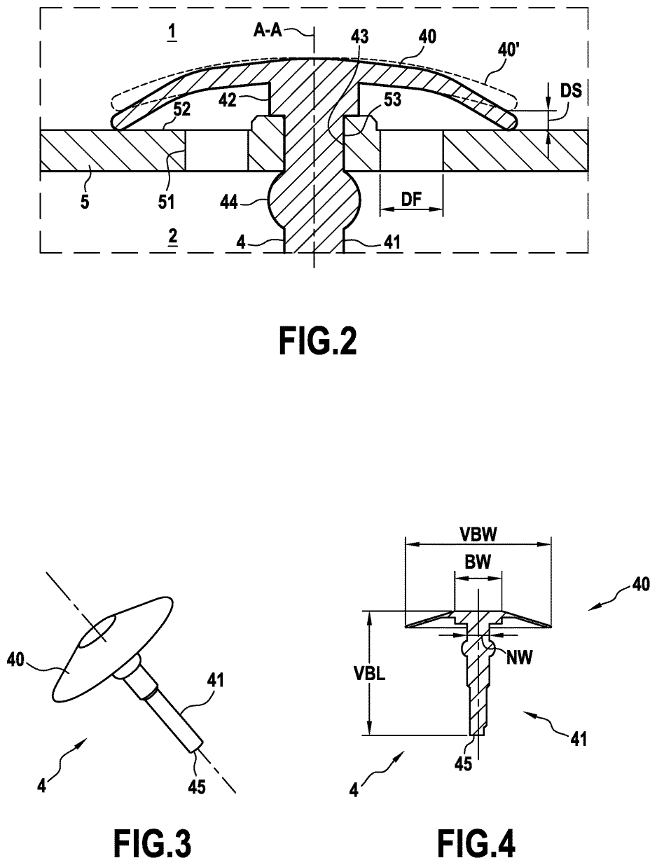

FIG. 2 shows a detailed cross-sectional view of the valve body 4 and separator wall 5 seen in FIG. 1A.

The separator wall 5 is generally impermeable to the liquid storable in the tank 1, but includes a fluid passage 51 through which the liquid stored in the tank 1 may traverse the separator wall 5. The fluid passage 51 may further admit gas (e.g. air) from the baffle/buffer system 2 to the tank 1 in order to replace the liquid dispensed into the baffle/buffer 2 from the tank 1. The separator wall 5 may include multiple fluid passages 51, so as to enable fluid exchange/communication between the tank 1 and the baffle/buffer system 2 at multiple locations on the separator wall 5, and/or so as to facilitate admission of gas to the tank 1 from the baffle/buffer system 2 concurrently with delivery of liquid from the tank 1 to the buffer 2. In the illustrated example, two fluid passages 51 are provided, though other quantities are also contemplated. Providing multiple fluid passage 51 may facilitate bidirectional fluid transfer between the baffle/buffer system 2 and the tank 1, and/or may facilitate flow of liquid from the tank 1 to the baffle/buffer system 2 even when the writing implement is oriented in such a manner as to cause a subset of the fluid passages 51 to emerge from the liquid in the tank 1.

In the illustrated example, two fluid passages 51 are provided, though other quantities are provided. Each fluid passage 51 may be provided as a through-hole, for example. In the illustrated example, each fluid passage is provided as a through-hole with a diameter DF of approximately 1.6 mm (millimeters). As a non-limiting example, whether one or multiple fluid passages 51 are provided, its/their combined cross-sectional area may be approximately 4.5 mm² (square millimeters) or less, or even 4.02 mm² or less. To be noted that the smallest cross-sectional area may depend on the overall system configuration and several parameters including the acceptable flow of ink that the applicator tip has to deliver to ensure appropriate working of the writing instrument.

The valve body 4 includes a flow control portion 40 and a mounting stem 41 connected thereto, by which the flow control portion 40 is connected to the separator wall 5. The mounting stem 41 is arranged to penetrate a mounting through-hole 53 provided in the separator wall 5, so as to align the flow control portion 40 relative to the fluid passage(s) 51. When the valve is in the open position, the flow control portion 40 is arranged to cover but not seal the fluid passage(s) 51.

The flow control portion 40 is provided as a membrane arranged towards the tank 1 with respect to the separator wall 5. The membrane is impermeable to the liquid, is mobile relative to the separator wall 5, e.g. through deformation. When the valve is in the closed position, the membrane contacts a sealing surface 52 of the separator wall 5 in a sealing manner. Through deformation of the flow control portion 40 towards the sealing surface 52, the valve is able to pass to the closed position. Contact between the sealing surface 52 and the flow control portion 40 can be seen in FIG. 2.

As a non-limiting example, the flow control portion 40—or even the valve body 4 as a whole—may be made of an elastomeric material. For example, the elastomeric material may be made or include (fluoro)silicone, ethylene propylene diene monomer (EPDM) rubber, nitrile rubber, etc., or mixtures thereof.

FIG. 3 shows a three-dimensional view of the valve body 4. The valve body 4 is substantially umbrella-shaped, insofar as the flow control portion 40 presents a convex surface and a concave surface, approximately in the form of a dome, and is centrally-supported by the mounting stem 41. As a non-limiting example, the dome may be spherical, conical, bell-shaped, etc. However, other valve body types are also contemplated.

The membrane is deformable so that an edge of the dome is brought into contact with the sealing surface 52 of the separator wall 5. Sealing contact between the dome and the sealing surface 52 causes closure of the valve.

The mounting stem 41 depends from the dome's concave surface, and terminates in a tip portion 45. The tip portion 45 is sized to be smaller than the mounting through-hole 53, so as to facilitate assembly of the valve body 4 to the separator wall 5.

Returning now to FIG. 2, it can be seen that the valve body 4 is connected to the separator wall 5 such that the concave surface of the dome faces the sealing surface 52.

The valve includes a spacer between the flow control portion 40 and the sealing surface 52. The spacer is sized such that when the valve body 4 is at rest (for example when the pressure difference across the valve is zero) the flow control portion 40 is separated from the sealing surface 52. The dashed contour 40′ provides a non-limiting exemplary representation of the position occupied by the flow control portion 40 when the valve body 4 is at rest.

When the internal pressure in the tank 1 matches the internal pressure in the buffer 2, a separation distance DS between the flow control portion 40 and the sealing surface 52 may be approximately 0.25 mm (millimeters) as measured perpendicular to the sealing surface 52. However, other separation distances are also contemplated.

In FIG. 2, the spacer is shown as including a platform on the separator wall 5, surrounding the mounting through-hole 53, and a base portion 42 of the mounting stem 41 arranged to separate the flow control portion 40 from the separator wall 5 (or platform), though other arrangements are also contemplated. For example, the relative dimensions of the platform and the base portion 42 may be determined freely; in examples, the spacer may be formed entirely of the platform or entirely of the base portion 42.

The base portion 42 is larger in cross-section (as measured perpendicular to an axis A-A running from the base portion 42 to the tip portion 45) than the mounting through-hole 53.

The mounting stem 41 includes a neck portion 43 extending towards the tip portion 45 from the base portion 42. The neck portion 43 is sized to fit within the mounting through-hole 53. The length of the neck portion 43 is sized according to the thickness of the separator wall 5 as measured along the axis A-A running from the base portion 42 to the tip portion 45.

The mounting stem 41 includes a retainer portion 44 between the neck portion 43 and the tip portion 45. The retainer portion 44 is sized to be snap-fittable through the mounting through-hole 53. Accordingly, it is wider than the mounting through-hole 53, but deformable to pass therethrough with effort during assembly of the valve. The retainer portion 44 is adjacent to the neck portion 43. When the neck portion 43 is arranged within the mounting through-hole 53, the base portion 42 and the retainer portion 44 bear concurrently on opposite surfaces of the separator wall 5 (e.g. on opposing rims of the mounting through-hole 53). When no base portion 42 is provided, the flow control portion 40 bears on the platform directly with the retainer portion 44 bearing on the separator wall 5.

FIG. 4 shows the valve body 4 in cross-section. The overall length VBL of the valve body 4, as measured from the convex surface of the dome of the flow control portion 40 to the free end of the tip portion 45 may be 12.9 mm (millimeters). The overall width VBW of the valve body 4, as measured from edge to edge of the dome (e.g. the diameter of the membrane) may be 10.35 mm. The neck portion 43 may have a width NW (or diameter) of 1.57 mm. The base portion 42 may have a width BW (or diameter) of 3.05 mm.

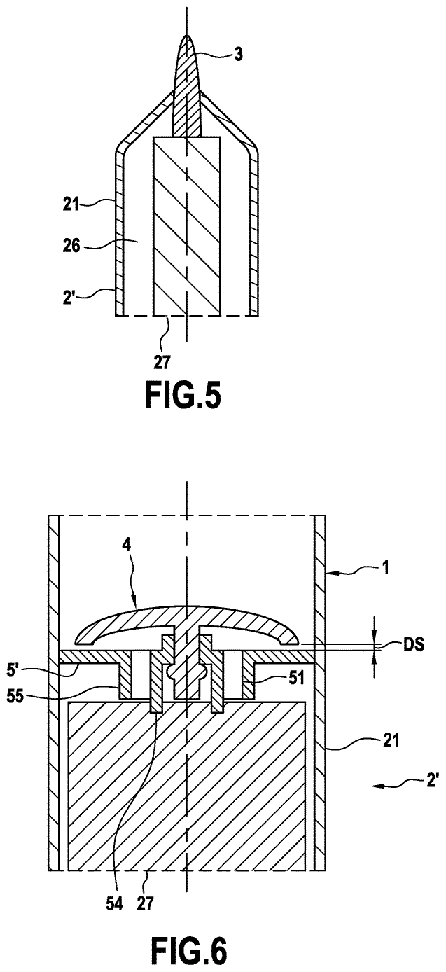

FIG. 5 shows a cross-sectional view of a buffer system 2′ and an applicator tip 3. The buffer 2′ differs from the baffle/buffer system 2 illustrated in FIG. 1A in that the baffle/buffer system 2′ is a baffle/buffer chamber including a liquid storage medium 27 in contact with a liquid uptake surface of the applicator tip 3. The liquid storage medium 27 may be provided, for example, as a porous material capable of holding the liquid from the tank through capillary action.

When one or more gas passages is/are used in combination with a liquid storage medium 27, the liquid storage medium 27 may be positioned relative to the peripheral wall 21 such that a space 26 is provided between the liquid storage medium 27 and the peripheral wall 21. The gas passage(s) open(s) into this space 26, allowing gas to flow towards the tank.

FIG. 6 shows a cross-sectional view of the baffle/buffer system 2′ seen in FIG. 5 and a valve including a valve body 4 (shown here at rest with separation distance DS) and a separator wall 5′. In the separator wall 5′, differs from the separator wall 5 seen in FIG. 2 in that in the separator wall 5′ the rim(s) of the fluid passage(s) 51 extend(s) away from the tank 1/towards the applicator tip, to form one or more fluid guides 55. When the liquid storage medium 27 is provided, the fluid guide 55 is able to deliver liquid to a liquid uptake surface of the liquid storage medium 27. The fluid guide 55 is shaped so as to provide a gap between the liquid storage medium 27 and the rim of the fluid passage 51, so as to enable gas to flow into the fluid passage 51.

The separator wall 5′ includes a stabilizing portion 54 extending away from the tank 1/toward the applicator tip. The liquid storage medium 27 of the baffle/buffer system 2′ is connected to the stabilizing portion 54. In the illustrated example, the stabilizing portion 54 is arranged to extend towards the applicator tip from the fluid guide 55, though other locations are also contemplated.

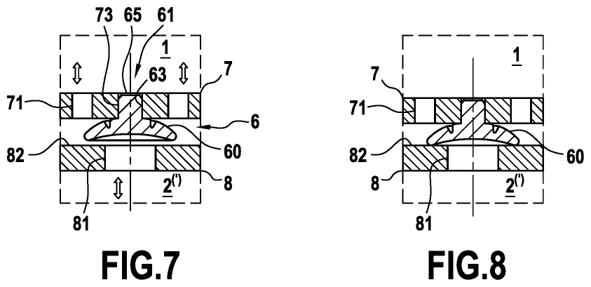

FIG. 7 shows a different valve to FIG. 1A. The valve shown in FIG. 7 is nevertheless compatible with the writing implements described herein. The reference 2^{(′)} is used to designate a baffle/buffer system, such as the buffers 2, 2′ visible in FIG. 1A and FIG. 5.

The valve shown in FIG. 7 differs from the valve shown in FIG. 2 or FIG. 6 in that it includes a valve body 6 arranged between a first separator wall 7, disposed towards the tank 1 with respect to the valve body 6, and a second separator wall 8, disposed towards the baffle/buffer system 2^{(′)} with respect to the valve body 6. The valve body 6 is mounted in the first separator wall 7 and is configured to cooperate sealingly with the second separator wall 8.

The first separator wall 7 and the second separator wall 8 are generally impermeable to the liquid storable in the tank 1, but collectively include fluid passages 71, 81 through which liquid may flow out of the tank 1 and into the baffle/buffer 2^{(′)}, and through which gas may be admitted from the baffle/buffer 2^{(′)} into the tank 1.

The first separator wall 7 includes one or more (here two or more) fluid passages 71, which differ from the fluid passages 51 illustrated in FIG. 2 and FIG. 6 at least in that the fluid passages 71 are always open, regardless of whether the valve is open or closed.

The valve body 6 includes a flow control portion 60 and a mounting stem 61 connected thereto, by which the flow control portion 60 is connected to the first separator wall 7. The mounting stem 61 is arranged to penetrate a mounting hole 73 provided in the first separator wall 7.

The flow control portion 60 is provided as a membrane arranged towards the second separator wall 8 with respect to the first separator wall. The membrane is impermeable to the liquid, is mobile relative to the first separator wall 7, e.g. through deformation. When the valve is in the closed position, the membrane contacts a sealing surface 82 of the second separator wall 8 in a sealing manner. Through deformation of the flow control portion 60 towards the sealing surface 82, the valve is able to pass from its open position to its closed position. Contact between the sealing surface 82 and the flow control portion can be seen in FIG. 8.

The material(s) listed for the flow control portion 40 and/or valve body 4 as a whole for FIG. 2 may be suitable for the flow control portion 60 and/or valve body 6 as a whole in FIG. 7-8.

The valve body 6 may be provided as a so-called Belleville valve body (as available from Minivalve, for example). When the valve body 6 is at rest, the flow control portion 60 includes a concave surface arranged away from the mounting stem 61, and a substantially convex surface arranged towards the mounting stem 61. The mounting stem 61 may be connected to a center of the convex surface, and a living hinge may be provided between the edge and the center of the flow control portion 60 to favor uniform movement of the edge of the flow control potion 60 during deflection.

The mounting stem 61 terminates in a tip portion 65. The mounting hole 73 may be provided as a blind hole, since the valve body 6 is held captive between the first separator wall 7 and the second separator wall 8, or may be provided as a through-hole as seen in the illustrated example.

The overall length VBL′ of the valve body 6′ may be measured between the tip portion 65 and the edge of the flow control portion 60 while the valve body 6 is at rest, as projected onto an axis running from the center of the convex of the flow control portion 60 in a direction normal to the convex surface of the flow control portion 60.

In the case of a blind mounting hole 73 in the first separator wall, the depth of the mounting hole 73 may be determined, based on the overall length VBL′ of the valve body 6 as compared to a distance between the first separator wall 7 and the second separator wall 8 as measured from a rim of the mounting hole 73 to a plane coincident with a sealing surface 82 of the second separator wall 8, in view of the separation distance desired between the edge of the flow control portion 60 and the sealing surface 82 when the valve body 6 is at rest.

The second separator wall 8 includes one (or more) fluid passages 81. As seen in FIG. 8, when the valve is open, fluid can pass through the fluid passage(s) 81; when the valve is closed, the valve body 6 prevents flow of fluid between the fluid passage(s) 81 of the second separator wall 8 and the fluid passage(s) 71 of the first separator wall 7. It is contemplated to provide a stabilizing portion and/or one or more guides on the second separator wall 8 as discussed for FIG. 6.

Although the foregoing disclosure has described the reservoir as being provided by a tank 1, it is also contemplated for the reservoir to be provided as a bladder. The bladder may be fluidly connected to the (first) separator wall 5, 7 and housed within a substantially rigid structure.

The writing implement may be fabricated by providing a reservoir, valve, baffle/buffer system 2, 2′, and applicator tip 3, and connecting the reservoir, valve, baffle/buffer system 2, 2′, and applicator tip 3 to one another such that the reservoir and baffle/buffer system 2, 2′ are on opposite sides of the valve, and such that fluid flow between the reservoir and the applicator tip 3 occurs via the valve and baffle/buffer system 2, 2′ in series. Connection of the baffle/buffer system 2, 2′ and applicator tip 3 to one another may occur prior to, concurrently with, or subsequent to connection of the reservoir, valve, and baffle/buffer system 2, 2′ to one another.

Providing the reservoir may occur prior to connecting the reservoir, valve, and baffle/buffer system 2, 2′ to one another, or concurrently with connecting the reservoir, valve, and baffle/buffer system 2, 2′ to one another.

Providing the reservoir may entail connecting a liquid-filled or liquid-fillable cavity to a (first) separator wall 5, 5′, 7. If the reservoir makes use of the bladder-with-substantially-rigid-structure architecture described above, this step entails connecting the (first) separator wall 5, 5′, 7, to the bladder and to the substantially rigid structure such that the bladder separates the fluid passage(s) 51, 71 in the separator wall from the substantially rigid structure.

Liquid may be provided in cavity prior connecting the reservoir and valve to one another.

If the valve has an architecture similar to the valve in FIG. 2 or 6, providing the valve may include mounting a valve body 4 to a separator wall 5, 5′, prior to connecting the reservoir and valve to one another. When the reservoir is connected to the valve, the valve body 4 is arranged towards the reservoir with respect to the separator wall 5, 5′.

If the valve has an architecture similar to the valve in FIGS. 7-8, fabrication may include connecting the connecting the liquid-filled or liquid-fillable cavity to the first separator wall 7, connecting a valve body 6 to the first separator wall 7, and connecting a second separator wall 8 to the first separator wall 7 after the valve body 6 has been connected to the first separator wall 7. When the first separator wall 7 is connected to the liquid-filled cavity and the valve body 6 is connected to the first separator wall 7, the valve body 6 is arranged away from the liquid-filled or liquid-fillable cavity with respect to the first separator wall 7. The second separator wall 8 may be connected to the first separator wall 7 concurrently with connection of the reservoir, valve, and buffer 2, 2′ to one another (e.g. the second separator wall 8 may be connected to the baffle/buffer system 2, 2′ prior to connecting the reservoir, valve, and baffle/buffer system 2, 2′ to one another), or may be connected to the first separator wall 7 prior to connection of the baffle/buffer 2, 2′ to the valve (e.g. the second separator wall 8 may be connected to the reservoir prior to connecting the baffle/buffer system 2, 2′ to the valve).

If the buffer has an architecture similar to the baffle/buffer system 2′ seen in FIGS. 5-6, the liquid storage medium 27 may be connected to the stabilizing portion of the (second) separator wall 5′, 8 prior to or concurrently with connection of the peripheral wall 21 to the (second) separator wall 5′, 8. The liquid uptake surface of the applicator tip 3 may be connected to the liquid storage medium 27 prior to, concurrent with, or subsequent to connection of the liquid storage medium 27 to the (second) separator wall 5′, 8.

Although the present disclosure herein has been described with reference to particular embodiments, it is to be understood that these embodiments are merely illustrative of the principles and applications of the present disclosure.

It is intended that the specification and examples be considered as exemplary only, with a true scope of the disclosure being indicated by the following claims.

Additionally, all of the disclosed features of an apparatus may be transposed, alone or in combination, to a method and vice versa.

1. A writing implement comprising a reservoir for storing a liquid, an applicator tip for depositing the liquid on a surface, a baffle or buffer system connected to the reservoir via a valve and connected to the applicator tip so as to transport the liquid from the reservoir to the applicator tip, the valve being normally-open and configured to close, to prevent flow of the liquid from the reservoir to the baffle or buffer system, in response to internal pressure within the reservoir exceeding a reference pressure outside of the reservoir by more than a predetermined amount.

2. The writing implement of claim 1, wherein the valve includes a separator wall including one or more fluid passages for fluid exchange between the reservoir and the baffle or buffer system, the valve includes a flow control portion arranged towards the reservoir with respect to the separator wall so as to hide the one or more fluid passages while the valve is in the open position, as viewed along a direction of flow of the liquid through one of the one or more fluid passages from the reservoir to the baffle or buffer system, the flow control portion being configured to contact a sealing surface of the separator wall to close the valve.

3. The writing implement of claim 2, wherein the flow control portion is deformable so as to contact the sealing surface to close the valve.

4. The writing implement of claim 2, wherein the valve includes a mounting stem configured to cooperate penetratively with a mounting through-hole provided in the separator wall to connect the flow control portion to the separator wall.

5. The writing implement of claim 4, wherein the valve includes a spacer between the flow control portion and the sealing surface, the mounting stem includes a neck portion configured to fit within the mounting through-hole, a retainer portion positioned opposite the neck portion from the spacer such that when the neck portion is arranged within the mounting through-hole, the separator wall is arranged between the retainer portion and the spacer.

6. The writing implement of claim 5, wherein the retainer portion is snap-fittable through the mounting through-hole.

7. The writing implement of claim 3, wherein a separation distance between the flow control portion and the sealing surface is 0.25 mm or less when the valve is in the open position.

8. The writing implement of claim 2, wherein the one or more fluid passages has a total cross-sectional area of 4.5 mm² or less.

9-15. (canceled)

16. The writing implement of claim 2, wherein the one or more fluid passages has a total cross-sectional area of 4.02 mm² or less.

17. The writing implement of claim 1, wherein the predetermined amount is 10 mbar or less.

18. The writing implement of claim 17, wherein the predetermined amount is equal to or greater than 4 mbar and equal to or less than 8 mbar.

19. The writing implement of claim 18, wherein the predetermined amount is 6 mbar+/−20%.

20. The writing implement of claim 1, wherein the valve is an umbrella valve.

21. The writing implement of claim 20, wherein the umbrella valve comprises a dome shaped elastic valve body which provides a sealing function in the backflow direction when mounted in a seat.

22. The writing implement of claim 1, wherein the baffle or buffer system includes a gas passage for admitting gas into the writing implement.

23. The writing implement of claim 22, wherein the gas passage is configured to admit gas into the baffle or buffer system, and the reservoir is configured to accept gas from the baffle or buffer system via the valve.

24. The writing implement of claim 22, comprising a removable closure configured to reversibly and concurrently separate the applicator tip and gas passage from an environment of the writing implement.
